(19) United States
(12) Patent Application Publication
(10) Pub. No.: US 2014/0238936 A1
(43) Pub. Date: Aug. 28, 2014

(54) REVERSE OSMOSIS AND NANOFILTRATION MEMBRANE CLEANING

(71) Applicants: Maqsood Fazel, Cheshire (GB); Stephen Chesters, Cheshire (GB)

(72) Inventors: Maqsood Fazel, Cheshire (GB); Stephen Chesters, Cheshire (GB)

(73) Assignee: Genesys International Limited, Cheshire (GB)

(21) Appl. No.: 13/780,046

(22) Filed: Feb. 28, 2013

(51) Int. Cl. B01D 65/02

(52) U.S. Cl. CPC B01D 65/02
USPC 210/636; 210/321.69; 261/62

(57) ABSTRACT

A method of cleaning a reverse osmosis or nanofiltration membrane includes supplying pulses of bubbles to the membrane. A venturi device for supplying bubbles to improve the cleaning of reverse osmosis or nanofiltration membranes includes a venturi having a liquid inlet and an air inlet provided at a choke point of the venturi, as well as an outlet. The air inlet is provided with a plurality of tubes. A reverse osmosis plant includes a membrane pressure vessel having a fluid inlet, a permeate outlet, a concentrate outlet and an in place cleaning tank connected in line with the fluid inlet. A venturi valve is connected in-line between the cleaning tank and the fluid inlet.

The present invention relates to improvements in or relating to methods and apparatus for the cleaning of reverse osmosis (RO) and nanofiltration (NF) membranes. Improved cleaning results in significant savings in electricity pumping costs with increased RO and NF plant operating efficiency.

A rapidly increasing world population has led to an ever increasing demand for desalinated water. There has been a dramatic increase in the number of reverse osmosis and nanofiltration plants over the last ten years. Reverse osmosis (RO) spiral wound membranes are considered to provide the finest form of water filtration, with an average salt rejection of 99%. There are currently estimated to be 20,000 RO plants worldwide containing over 1.25 million membrane elements.

There has also been a proliferation in the variety of feed water sources used, including seawater, surface waters and increasingly, effluents of varying qualities. Not surprisingly, therefore, is the parallel increase in the degree of scaling & fouling, resulting in a significant market need for not only novel preventative antiscalant products in the field, but also new and improved membrane cleaners where deposition has occurred. During normal operation, all RO membrane elements are subject to fouling from small particulate/colloidal matter (<2 μm) that is difficult to remove from feed streams using pre-treatments. Membrane fouling, limits operating flux, decreases water production, increases power consumption & requires periodical membrane in-place cleaning (CIP) procedures. Common examples of foulants include calcium carbonate scale; sulfate scale of calcium, barium or strontium; metal oxides (iron, manganese, copper, nickel, aluminum, etc.); polymerized silica scale; inorganic colloidal deposits; mixed inorganic/organic colloidal deposits; natural organic matter; synthetic (man-made) organic material and biological material (bacterial bioslime, algae, mold, or fungi).

The nature and rapidity of fouling depends on a number of factors, such as the quality of the feedwater and the system recovery rate. Typically, fouling is progressive, and if not controlled early, will impair the RO membrane element performance in a relatively short time. Cleaning should occur when the RO shows evidence of fouling, just prior to a long-term shutdown, or as a matter of scheduled routine maintenance. Typically RO membranes require cleaning every 3-12 months and replacing every 2-3 years, due to fouling.

A membrane is a layer of material which serves as a selective barrier between two phases and remains impermeable to specific particles, molecules, or substances when exposed to the action of a driving force. Some components are allowed passage by the membrane into a permeate stream, whereas others are retained by it and accumulate in the retentate stream.

There are significant differences in the design, purpose and materials of construction and properties of different membranes which include: Microfiltration (MF), Ultrafiltration (UF) (Membrane Bioreactors MBR's use a combination of microbiology and UF systems to recycle water), Nanofiltration (NF) and Reverse Osmosis (RO).

UF/MF membranes are designed to remove suspended matter and colloids, with a minimum particle size removal of 0.1 to 3 μm and removes particles/turbidity bacteria and protozoa from waters. UF generally has a minimum particle size removal of 0.01 to 0.1 μm and removes particles/turbidity, bacteria, protozoa and viruses. RO and NF membranes, on the other hand, also remove inorganic compounds to an ionic level—including both monovalent ions such as Na & Cl and also divalent ions such as Ca & SO4. In desalination UF/MF are essentially pre-treatment systems prior to the RO membranes, they are distinctly different in purpose, material, construction and filtration capacity.

Microfiltration (MF) is characterised by a membrane pore size between 0.05 and 2 μm and operating pressures below 2 bar. Ultrafiltration (UF) is characterised by a membrane pore size between 2 nm and 0.05 μm and operating pressures between 1 and 10 bar. Nanofiltration (NF) is characterised by a membrane pore size between 0.5 and 2 nm and operating pressures between 5 and 40 bar. NF is used to achieve a separation between sugars, other organic molecules and multivalent salts on one hand and monovalent salts and water on the other.

Reverse osmosis (RO) or hyperfiltration. RO membranes are considered not to have pores. Transport of the solvent is accomplished through the free volume between the segments of the polymer of which the membrane is constructed. The operating pressures in RO are generally between 10 and 100 bar.

The nature of these filtration methods requires distinctly different materials of construction between UF/MF and RO/NF membranes. MF and UF membranes are constructed from chemically resistant polymeric material with high mechanical strength such as: PS—polysulfone, PES—Polyether sulfone, PAN—Polyacrilonitrile, PVDF—Polyvinylidiene fluoride, PP—Polypropylene, PE—Polyethylene, PVC—Polyvinyl chloride.

RO and NF membranes are constructed from 0.2 μm polyamide salt rejecting layers which are extremely delicate and easily damaged through oxidation and abrasion. Some RO and NF membranes are constructed from cellulose acetate which have some resistance to oxidation but are prone to attack by bacteria. The sensitivity and mode of operation of RO and NF membranes makes them completely different to the other types of membranes described above.

The structure of these different types of membranes are also distinctly different, the majority of UF/MF systems are hollow fibre or tubular membranes while RO membranes consist of a number of flat sheets wound spirally around a central collection tube. UF/MF systems filter water either in an outside/in flow or inside/out depending on the manufacturer.

Conventional cleaning methods of filtration membranes also differ significantly. Microfiltration and ultrafiltration membranes can be cleaned physically and chemically. Physical methods are based on mechanical forces to dislodge and remove foulants from the membrane surface such as forward and reverse flushing and air sparging. Physical cleaning can be combined with chemical cleaning using basic alkali, acid and oxidising commodity chemicals which weaken the cohesion forces between the surfaces and foulants.

UF/MF membranes are cleaned via backwash process which is hydraulic cleaning with permeate water; this occurs every 20-40 minutes for a duration of 30 seconds (depending on manufacturer and application) during normal operation. In addition UF/MF undergo Chemically Enhanced Backwash (CEB) usually with 200 ppm of oxidant at high pH, this typically occurs every 4-8 hours for a duration of 30 minutes. The direction of permeate flow can be reversed to enhance cleaning of UF/MF membranes, while in RO systems the CIP stream must flow in the feed direction. In RO/NF systems the CIP system is completely separate to the operational equipment and normal operation must stop to perform a membrane clean, duration is therefore a significant factor in RO/NF systems.

The techniques used to clean MF and UF membranes are completely unsuitable for NF and RO membranes. Reverse osmosis and nano filtration membranes are not cleaned using physical methods due to the delicate nature of the membrane salt rejecting layer. RO plant tend to be cleaned using a blend of commodity chemicals or proprietary cleaning chemicals which comply with limitations set by the membrane manufacturers. These formulations are typically based on generic chemical formulations that have been enhanced or modified through the suppliers' own R&D. Alternative methods of recovering membrane performance include Direct Osmosis at High Salinities (DO-HS). Air scouring using compressed air has been used on ultrafiltration membranes, when bubbles expand and collapse close to surface boundaries, a shear flow is generated which is able to remove particles from the surface. However, the 2 μm polyamide surface of an RO membrane is at a molecular level and very easily damaged by scouring and use of compressed air. For this reason air scouring has not been adopted as a cleaning aid for on RO or NF membranes.

The present invention seeks to provide an improved method for cleaning reverse osmosis and nanofiltration membranes, and apparatus associated therewith.

Accordingly there is provided a method of cleaning reverse osmosis (RO) or nanofiltration (NF) membranes comprising supplying pulses of bubbles to the membrane.

The pulses of bubbles result in a more even distribution of cleaning solution across the membrane surface, avoiding channeling.

Preferably, the pulses of bubbles are suspended in a stream of cleaning solution.

Preferably the bubbles are created by a venturi device.

Preferably the bubbles are stabilised by a cleaning product provided in the liquid stream.

Preferably the flow of bubbles is enhanced by use of an effervescent cleaning product.

Preferably the cleaning product includes a surfactant.

Preferably the cleaning product is a powdered cleaning product. Most preferably the cleaning product is one of Genesol® 701, Genesol® 703, or Genesol® 704.

Preferably the method comprises supplying a first flow of fluid containing a pulse of bubbles and a first cleaning product then supplying a second flow containing a pulse of bubbles and a second cleaning product.

In this case, preferably the first cleaning product is Genesol® 704 and the second cleaning product is Genesol® 701.

In a second aspect of the invention, there is provided a venturi device for supplying bubbles to improve cleaning of RO or NF membranes, the venturi comprising a liquid inlet, an air-inlet provided at a choked portion of the venturi and an outlet; wherein the air inlet is provided with a plurality of tubes.

Preferably the plurality of tubes are capillary tubes.

Preferably the plurality of tubes have a length and diameter adapted to cause pulses of bubbles to enter the liquid flow through the device.

Preferably the diameter of the plurality of tubes is between 0.5 and 1.0 mm, and preferably the length of the plurality of tubes is between 10 and 50 mm.

Preferably the plurality of tubes as from 2 to 16 tubes. More preferably at least 8 tubes. Most preferably 8 tubes are provided.

In a third aspect of the invention there is provided a RO plant comprising a membrane pressure vessel having a fluid inlet, a permeate outlet and a concentrate outlet and an in place cleaning tank connected in line with the fluid inlet; characterised in that a venturi valve is connected in-line between the cleaning tank and the fluid inlet.

Preferably the venturi is connected in line via a bypass line.

Preferably the venturi valve is a venturi device as defined above.

Preferably the RO plant is adapted to carry out the method defined above.

In the method, venturi device or RO plant discussed above, it is preferred that the bubbles produced are between 50 and 500 μm in size. Most preferably at least some bubbles are between 50 and 100 μm and at least some bubbles are between 100 and 500 μm.

The above and other aspects of the present invention will now be described in further detail, by way of example only, with reference to the accompanying figures in which:

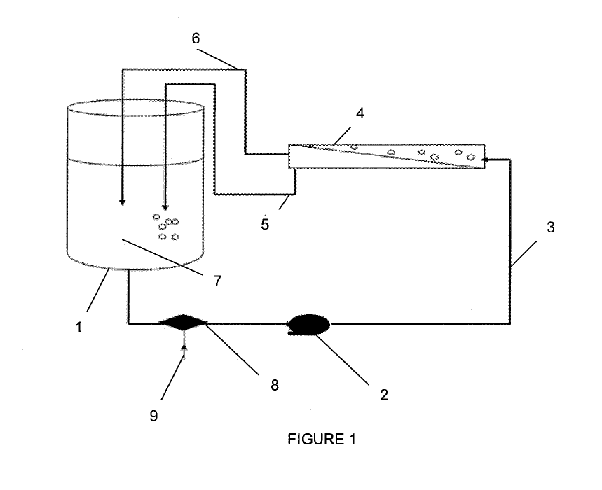

FIG. 1 shows, schematically, an embodiment of a reverse osmosis membrane cleaning system in accordance with the present invention;

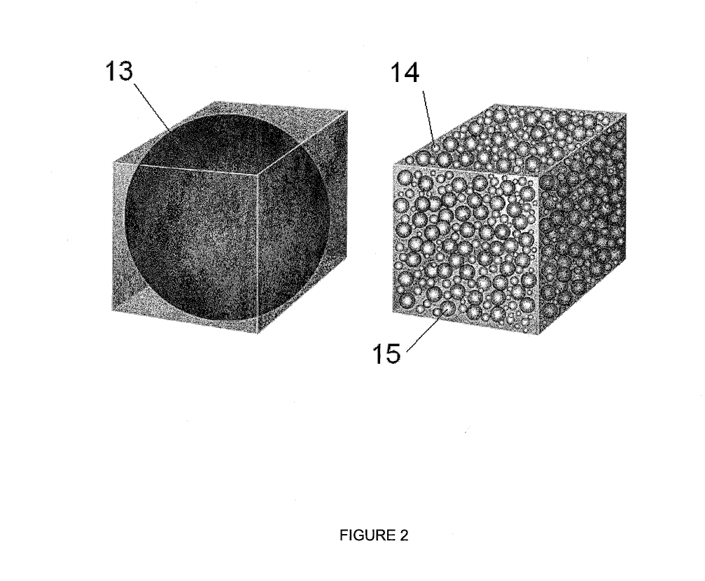

FIG. 2 shows schematically different sized bubbles;

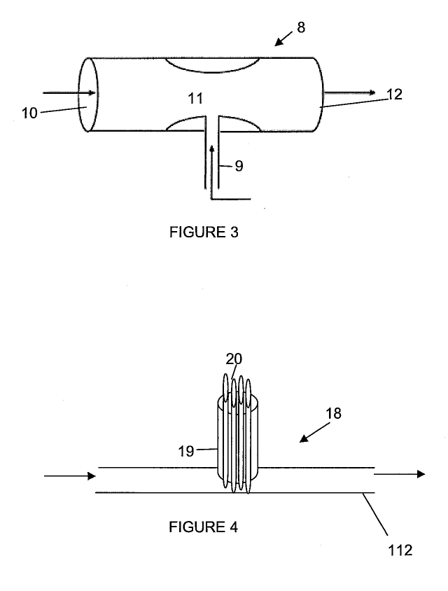

FIG. 3 is a schematic representation of a venturi valve;

FIG. 4 is a schematic representation of a venturi valve containing air inlet capillary tubes.

FIG. 1 illustrates a system for in-place cleaning of reverse osmosis or nanofiltration membranes in a membrane pressure vessel 4. The membrane pressure vessel 4 is coupled to a feed line 3 on an inlet side of the vessel 4 and a permeate line 5 and concentrate line 6 on the outlet side of the vessel 4. For the purposes of in-place cleaning of the membranes of membrane pressure vessel 4 feed line 3 forms a CIP feed line and is coupled to a tank 1 containing a cleaning solution 7 from where cleaning solution 7 is pumped to vessel 4 by a low pressure pump 2; and permeate line 5 and concentrate line 6 drain into tank 1. These features are generally conventional.

The present invention is based on the determination that small bubbles can be used to assist in chemical cleaning of the membranes without causing damage to the membranes. Large bubbles tend not to flow well over the membrane surface and result in channeling. Large bubbles also can cavitate and implode causing damage to the polyamide membrane layer. Conventional gas liquid bubbles which could be produced by compressed gas and would cause such damage can be considered to be more than 500 μm up to 2-3 mm in size.

Smaller bubbles have been created by using a venturi device 8, which as shown in FIG. 1 is in this embodiment of the invention located in the feed line 6 between the tank 1 and the membrane pressure vessel 4. Different chemicals are included in the cleaning solution to inhibit coalescence. As shown in more detail in FIG. 3, a venturi device 8 has a liquid inlet 10, air inlet 9, at a choked portion 11 and an outlet 12 through which a gas/liquid mixture, containing air bubbles drawn in by the venturi exits the device. Bubble size can be represented as per table below.

| Description | Size | | Production |
|---|---|---|---|
| Nanobubble | 0.5-5 | μm | Ultra-sound, pressure |
| Microbubble | 5-50 | μm | Ultrasound, pressure, venturi, chemicals |
| Minibubble | 50-100 | μm | Venturi, chemicals |
| Midibubble | 100-500 | μm | Venturi, chemicals |

In one arrangement, the cleaning solution added to the tank 1 is a solution of an alkaline cleaner Genesol 704 (available from Genesys International Ltd of Middlewich, UK) which is formulated to remove deposits from the membrane surface but also imparts a physico-chemical effect on the bubbles generated so that mini and midi sized bubbles remain intact and do not coalesece to reform into larger conventional bubbles.

FIG. 2 shows the contrast between conventional bubbles 13, left hand side and the bubbles according to this invention. As can be seen, the numerous minibubbles 14 and midibubbles 15 produced by the invention lead to an increased surface area with many small bubbles. These bubbles, 14, 15 have been found to enhance the membrane cleaning process without damaging its delicate surface. The increased surface area created as the aerated cleaning solution exits the venturi 18 creates a pulsing effect. This is visible in the CIP tank 1 and in the viewing window of the flat sheet test rig. The pulsed effect of cleaning solution 7 on a fouled membrane has an additional benefit in deposit removal when compared with non pulsing solutions.

In accordance with a preferred embodiment of the present invention, air bubbles are generated by means of a novel venturi valve 18, shown in FIG. 4, in which air is admitted to the venturi line 19, through a unique design of multiple capillary tubes 20. The small bubbles are thus introduced to the CIP feed line 3 via outlet 112. Sufficient air is admitted from the atmosphere until a wide distribution of bubbles are seen in tank 1 and returning from the membrane pressure vessel 4.

The permeate line 5 and the concentrate line 6 are arranged to discharge below the cleaning solution 7 level in the CIP tank 1 to avoid excessive foaming.

A series of comparative trials were run using the conventional venturi valve of FIG. 3 and the new design incorporating capillary tubes 20 for air inlet which changes the distribution of bubbles produced, as disclosed in relation to FIG. 4.

The novel venturi-type injector 18 incorporating capillary tubes 20 as air intakes in combination with Genesol 701 or Genesol 704 cleaning chemicals (both available from Genesys International of Middlewich, UK) was used to generate non-pressurised air bubbles, to help agitate and facilitate the removal of deposits on the membrane surface as well as the membrane spacer material. Increasing the velocity of water creates a more turbulent cleaning system and hence a good distribution of bubbles, therefore this concept can be easily implemented into most existing RO installations.

In order to investigate the effects of this concept on membrane performance, extensive tests were performed using both conventional and novel venturi-type devices along with a flat sheet test rig with a viewing window to observe the mechanism of air bubbles during cleaning action. To achieve optimal cleaning and foulant/scale removal, both the velocity of flow of the cleaning solution together with the air bubble size was investigated. Further experiments were conducted on a small scale pilot plant in order to test the compatibility of air with 8-inch spiral wound membranes obtained from several major membrane manufacturers. In this study both fouled and new membranes were used, which were then subsequently autopsied to examine the cleaning performance.

A flat sheet test rig (not shown) is a small frame mounted unit designed to enable trials of flat sheet RO membranes. It comprises two stainless steel plates that effectively ‘clamp’ a flat sheet membrane. The rig includes instrumentation and control as would be expected. The feed water to the test cell was pressurized to 15 bar using a high pressure pump. The feed plate of the test cell also contained a polycarbonate viewing window in order to view the mechanism of air bubbles during cleaning. The cleaning procedure involved re-circulating a cleaning solution around the flat sheet rig with the addition of bubbles produced using a venturi device. The bubbles produced were clearly visible in the CIP tank. Although the pressure was kept constant throughout all experiments, the flow velocity of the cleaning solution allowed bubble size and pulsing effect to be varied in order to find the optimum cleaning conditions. By varying the flow rate, using the multi capillary venturi in conjunction with Genesol 701 or Genesol 704 it was possible to get an even distribution of aerated cleaning solution over the entire membrane surface. Other researchers have commented that when introducing cleaning solutions channeling occurs. The even distribution has an enhanced effect on cleaning. This can be seen through the viewing window of the flat sheet test rig. A variety of fouled and new membrane coupons, obtained from various membrane manufacturers were tested, where permeate flux and salt rejection were recorded to evaluate the impact of bubbles on the membrane performance. Genesys cleaning chemicals Genesol 701 and Genesol 704 were used, in conjunction with air bubbles, for cleaning procedures. For comparison, cleans were also performed using air bubbles and a selection of commodity and conventional cleaning chemicals.

Membrane performance was evaluated through determination of permeate flux and salt rejection.

The size of the membrane pieces used for testing on the flat sheet rig was 20×30 cm and the effective membrane area was 0.023 m². Each membrane sample was characterised according to the specific membrane manufacturers' own conditions for that membrane.

The bubbles were introduced by using the specially designed venturi air injector 18. If a pump forces a fluid flowing into the venturi tube 18, an increase in velocity occurs in the constricted part simultaneously with the decrease in pressure which leads to air being sucked in through the tube or in this case multiple capillary tubes 20. Pressure recovery takes place further downstream and the air bubbles drawn in collapse forming a wide distribution of different sized bubbles which then have a tendency to coalesce into larger bubbles around the venturi. In order to optimize cleaning it is preferable to maintain a wide distribution of different sized bubbles which was achieved with a combination of the multi capillary venturi 18 and cleaning chemicals Genesol 701 and Genesol 704.

The venturi air injectors were used combined with cleaning solution flow velocity to create the optimum bubble size and distribution for cleaning

Venturi type devices 18 were constructed using different numbers and sizes of capillary tubing. Different numbers, (two to sixteen) polyether sulphone tubes with a 0.5 mm diameter were tested. It was found that eight tubes gave the optimum bubble size distribution with the test equipment. Furthermore when a 2-4% cleaning solution of Genesol 701 or Genesol 704 was added to the cleaning water it was found that the bubble distribution remained stable and the cleaning solution pulsed out of the venturi device and into the CIP feed line 3 and membrane element vessel 4. Tests on fouled flat sheet test rig demonstrated that this venturi device pulse effect enhanced deposit removal from the membrane surfaces.

The use of air bubbles produced by a venturi together with cleaning chemicals for the cleaning of fouled spiral wound RO/NF membranes was tested and evaluated. The air bubbles were generated by the use of the venturi valve in the CIP pipe and the addition of cleaning chemicals Genesol 701 or Genesol 704 which prevented coalescing of the mini and midi bubbles formed.

The use of air-liquid to introduce small bubbles via a venturi was investigated in the laboratory using the Flat Sheet Rig. It was noticed that using only water and air created large bubbles that quickly coalesced and had minimum impact on the membrane surface. However, when the air-liquid was used in the presence of Genesol 701 or Genesol 704 this produced a large number of small bubbles. The formation of small bubbles increased the turbulence of the cleaning solution mixture and appeared from the exit of the venturi in a pulsed fashion leading to an improved cleaning effect (ie, more foulant removal).

The air inlet 9 at atmospheric pressure is opened to allow sufficient air to enter and mix with the cleaning solution creating small air bubbles that can be seen upon the return of the cleaning solution to the CIP tank. In addition to modifying the size of the air inlet to vary bubble size, it has been observed that an increase in the feed flow also increases the quantity of bubbles produced. Increasing the pump speed does not necessarily give a proportional increase in the flow rate through the cell when using the venturi. This is because as the pump speed is increased, the air intake also increases and so the cleaning solution flow may even be reduced or stay the same after some value. Experiments on the flat sheet test rig show that the use of a venturi 18 with a number of small tubes 20, together with a maximized feed flow (˜2 to 2.5 l/min) generated a sufficiently turbulent and pulsed cleaning solution to facilitate foulant removal. Lower speeds (<0.25 l/min) resulted in the bubbles taking a more direct path across the membrane surface (ie, not evenly spread out). The reduced flow results in channeling of the bubbles across the membrane surface.

### EXAMPLES

### 1|Clay+Iron-Fouled TFC-HR Membrane

Standard Test Conditions are:

The flux rate is measured at standard operating conditions for each membrane type. The recirculation rate was 1000 ml/min and normalised to 25° C. The cleaning solution was recirculated @ 40 psi for 30 mins followed by a soak for 30 mins, followed by recirculation for 1 hour at 25 to 30° C.

The following cleans were carried out:

TABLE 1
Cleaning programs

| | Membrane Foulant - Clay-Al-Silicates/Iron fouled membrane |
|---|---|
| 1a | Fouled membrane flux and salt rejection before clean |
| 1b | Performance after Clean with 1% Genesol 704 for 2 hours, pH 11.5 |
| | @ temperature 35° C. |
| 1c | Performance after Clean with 1% Genesol 701 for 2 hours, pH 2.6 @ |
| | temperature 15° C. |
| 2a | Fouled membrane flux and salt rejection before clean |
| 2b | Performance after Clean with 1% Genesol 704 + Air for 2 hours, pH |
| | 11.5 @ temperature 35° C. |
| 2c | Performance after Clean with 1% Genesol 701 + Air for 2 hours, pH |
| | 2.6 @ temperature 15° C. |
| 3a | Fouled membrane flux and salt rejection before clean |
| 3b | Performance after Clean with 0.5% NaOH for 2 hours, pH 12 @ |
| | temperature 35° C. |
| 3c | Performance after Clean with 2% citric acid for 2 hours, pH 2 @ |
| | temperature 15° C. |
| 4a | Fouled membrane flux and salt rejection before clean |
| 4b | Performance after Clean with 0.5% NaOH + Air for 2 hours, pH 12 |
| | @ temperature 35° C. |
| 4c | Performance after Clean with 2% Citric Acid + Air for 2 hours, pH 2 |
| | @ temperature 15° C. |

TABLE 2
Results: Clay-Al-Silicates/Iron fouled membrane
Genesol 701 & Genesol 704 & Air

| | | | |
|---|---|---|---|
| 2000 ppm | | % salt | Δ |
| NaClFlux | ΔFlux | rejec- | Turbidity |
| (lm²/h | (%) | tion | (NTU) |

Comparative Example 1 - G704 ~& G701

| | | | | |
|---|---|---|---|---|
| 1a) Fouled membrane | 29.2 | — | 97% | — |
| 1b) 3 hr clean with 1% | 38.4 | +32% | 98.6% | 1 → 112 |
| G704 (35° C.) | | | | |
| 1c) Additional 2 hr clean | 37.8 | +29% | 98.7% | 5 → 15 |
| with 1% G701 (15° C.) | | | | |

Example 1 - G704 & G701 + air

| | | | | |
|---|---|---|---|---|
| 2a) Fouled membrane | 26.5 | — | 96.1% | — |
| 2b) 3 hr clean with 1% | 37.0 | +40% | 98.3% | 4 → 110 |
| G704 + air (35° C.) | | | | |
| 2c) Additional 2 hr clean | 40.2 | +52% | 98.7% | 4 → 4 |
| with 1% G701 + air (15° C.) | | | | |

Tests conducted against common membrane foulants combined; as iron and aluminosilicates (clays) results have shown that a combination of air bubbles, generated in situ with cleaning chemicals (example 1) enhances membrane performance, with an increase in both permeate flux and salt rejection. The cleaning solution turbidity is also measured. Where turbidity increases this is a measure of the quantity of colloidal deposits removed from the membrane surface. The cleaning effectiveness can be easily seen upon visual inspection of membrane coupons. Subsequent autopsy results reveal that the air bubbles produced by this venturi method caused no damage to the membrane surface.

TABLE 3
Results Clay-Al-Silicates/Iron fouled membrane Commodity
Cleaners & Commodity cleaners plus air
Comparative Example 2 - NaOH & Citric

| | | | | |
|---|---|---|---|---|
| 3a) Fouled membrane | 25.3 | — | 95.2% | — |
| 3b) 3 hr clean with 0.2% NaOH | 26.4 | +4% | 96.2% | 4 → 19 |
| (35° C.) | | | | |
| 3c) Additional 2 hr clean with | 25.6 | +1% | 96.2% | 2 → 2 |
| 2% citric (15° C.) | | | | |

Example 2 - NaOH & Citric + air

| | | | | |
|---|---|---|---|---|
| 3a) Fouled membrane | 26.9 | — | 97.9% | — |
| 3b) 3 hr clean with 0.2% | 31.6 | +17% | 98.2% | 4 → 38 |
| NaOH + air (35° C.) | | | | |
| 3c) Additional 2 hr clean with | 26.5 | −2% | 98.5% | 4 → 11 |
| 2% citric + air (15° C.) | | | | |

It can be seen that when air bubbles are used in combination with commodity cleaning chemicals, membrane performance is not restored to the same magnitude as with Genesol 701 and Genesol 704. (Genesol 701—is a proprietary powdered blend of acids, chelants, surfactants, effervescent reagents and ionic strength builders which remove metals and mineral scales from RO and NF membranes. Genesol 704—is a proprietary powdered blend of alkaline detergents, chelants, surfactants, effervescent reagents and ionic strength builders which removes organics, biofouling, silts, clays and colloidal particles from RO and NF membranes.) The best results are achieved with Genesol 701 and Genesol 704 and the introduction of air as small bubbles. It is evident that upon contact with Genesol 701 and Genesol 704 the size of the air bubbles generated by the venturi device is significantly reduced, which would create more turbulence within the cleaning solution and agitate the foulant on the membrane surface to ease its removal. Because Genesol 701 is acidic it can tighten the membrane which may decrease the flux, but correspondingly increase the % salt rejection

Autopsies were carried out on virgin and cleaned membranes to establish effect of cleaning with air and cleaning chemicals. The autopsies were done in order to reveal membrane integrity and the amount of foulant removed by cleaning. The autopsy involved visual inspection of the elements, Scanning Electron Microscopy—Energy Dispersive X-ray Analysis (SEM-EDXA) and Infra-red to identify the elemental composition of the foulants and examine integrity of the membrane surface, Fujiwara and dye test for chemical, oxidation or physical damage of the membrane surface.

### 2—Clay Fouled TFC-HR Membrane

Standard Test Conditions are:

The flux rate is measured at standard operating conditions for each membrane type. The recirculation rate was 1000 ml/min and normalised to 25 C. The cleaning solution was recirculated @ 30 psi for 30 mins followed by a soak for 30 mins followed by recirculation for 1 hour at 25 to 35 C.

The following cleans were carried out on a different type of membrane:

TABLE 4
Cleaning programmes:

| Tests | Clay fouled TFC-HR membrane: |
|---|---|
| 1a | Fouled membrane flux and salt rejection before clean |
| 1b | Performance after Clean with Genesol 701 for 2 hours, pH 2.6 @ |
| | temperature 15° C. |
| 1c | Performance after Clean with Genesol 704 for 2 hours, pH 11.5 @ |
| | temperature 30-35° C. |
| 2a | Fouled membrane flux and salt rejection before clean |
| 2b | Performance after Clean with Genesol 701 + Air for 2 hours, pH |
| | 2.6 @ temperature 15° C. |
| 2c | Performance after Clean with Genesol 704 + Air for 2 hours, pH |
| | 11.5 @ temperature 30-35° C. |
| 3a | Fouled membrane flux and salt rejection before clean |
| 3b | Performance after Clean with 0.5% HCl + Air for 2 hours, pH 2.0 |
| | @ temperature 15° C. |
| 3c | Performance after Clean with 0.5% NaOH + Air for 2 hours, pH |
| | 12 @ temperature 30-35° C. |

The results are shown in Table 5.

TABLE 5
Results

| | | | |
|---|---|---|---|
| | 2000 ppm | | % SALT |
| | NaCl FLUX | % FLUX | REJEC- |
| TEST | (l/m²h) | CHANGE | TION |

Comparative Example 3: Clay fouled membrane

| | | | |
|---|---|---|---|
| 1a) Before Clean | 45.8 | — | 98.8 |
| 1b) After 2 hr clean with | 43.4 | −5% | 99.0 |
| 1% Genesol 701 pH 2.6 @ 15° C. | | | |
| 1c) Follow on clean with | 57.0 | +24% | 99.0 |
| 1% Genesol 704, pH 11.5 @ | | | |
| 35° C. | | | |

Example 3: Clay fouled membrane + Air

| | | | |
|---|---|---|---|
| 2a) Before Clean | 49.0 | | 98.8 |
| 2b) After 2 hr clean with | 55.7 | +14% | 99.0 |
| 1% Genesol 701 + Air pH 2.6 @ | | | |
| 15° C. | | | |
| 2c) Follow on clean with | 65.0 | +33% | 99.0 |
| 1% Genesol 704 + Air pH 11.5 @ | | | |
| 35° C. | | | |

Example 4: Clay fouled membrane + Air

| | | | |
|---|---|---|---|
| 3a) Before Clean | 47.2 | | 99.1 |
| 3b) After 2 hr clean with 0.5% | 47.7 | +0% | 99.2 |
| HCl + Air, pH 2 @ 15° C. | | | |
| 3c) Follow on clean with | 54.4 | +15% | 99.1 |
| 0.5% NaOH + Air, pH 12 @ | | | |
| 35° C. | | | |

It can be seen that when air bubbles are used in combination with commodity cleaning chemicals, membrane performance is not restored to the same magnitude as with Genesol 701 and Genesol 704. Genesol 701 and Genesol 704 produce a higher flux recovery than commodity chemicals with air bubbles. The best results in terms of flux recovery are achieved with Genesol 701 and Genesol 704 and the introduction of air as small bubbles.

Additional tests were carried out on a biofouled membrane, to compare the effect of air bubbles using the capillary venturi together with both proprietary cleaners discussed above and bulk cleaners, the results are set out in table 6 below.

TABLE 6
Results

| | | | | |
|---|---|---|---|---|
| Biofilm/Calcium | 2000 ppm | | % Salt | Δ |
| Phosphate fouled | NaCl Flux | ΔFlux | Rejec- | Turbidity |
| membrane | (lm²/h) | (%) | tion | (NTU) |

Comparative example 4 - G703

| | | | | |
|---|---|---|---|---|
| 1a) Fouled membrane | 30.1 | — | 98.2% | — |
| 1b) 2 hr clean with | 35.9 | +19% | 98.4% | 2 → 2 |
| 1% G703 (35° C.) | | | | |
| 1c) Additional 2 hr | 37.7 | +25% | 98.5% | 2 → 2 |
| clean with 1% G703 | | | | |
| (35° C.) | | | | |

Example 5 - G703 + air

| | | | | |
|---|---|---|---|---|
| 2a) Fouled membrane | 31.7 | — | 98.7% | — |
| 2b) 2 hr clean with | 40.7 | +28% | 98.3% | 2 → 11 |
| 1% G703 + air (35° C.) | | | | |
| 2c) Additional 2 hr | 43.6 | +38% | 98.2% | 1 → 4 |
| clean with 1% G703 + air | | | | |
| (35° C.) | | | | |

Comparative example 5 - G704

| | | | | |
|---|---|---|---|---|
| 3a) Fouled membrane | 29.8 | — | 98.2% | — |
| 3b) 2 hr clean with | 41.4 | +38% | 98.5% | 1 → 7 |
| 1% G704 (35° C.) | | | | |
| 3c) Additional 2 hr | 45.7 | +53% | 98.6% | 1 → 2 |
| clean with 1% G704 | | | | |
| (35° C.) | | | | |

Example 6 - G704 + air

| | | | | |
|---|---|---|---|---|
| 4a) Fouled membrane | 31.1 | — | 98.1% | — |
| 4b) 2 hr clean with | 38.8 | +25% | 98.2% | 2 → 3 |
| 1% G704 + air (35° C.) | | | | |
| 4c) Additional 2 hr | 40.6 | +31% | 98.1% | 2 → 2 |
| clean with 1% G704 + air | | | | |
| (35° C.) | | | | |

Comparative example 6 - NaOH

| | | | | |
|---|---|---|---|---|
| 7a) Fouled membrane | 31.4 | — | 98.7% | — |
| 7b) 2 hr clean with | 41.3 | +32% | 98.4% | 1 → 10 |
| 0.2% NaOH (35° C.) | | | | |
| 7c) Additional 2 hr | 40.8 | +30% | 97.9% | 1 → 4 |
| clean with 0.2% NaOH | | | | |
| (35° C.) | | | | |

Example 7 - NaOH + air

| | | | | |
|---|---|---|---|---|
| 8a) Fouled membrane | 30.7 | — | 97.3% | — |
| 8b) 2 hr clean with | 40.4 | +32% | 98.1% | 1 → 9 |
| 0.2% NaOH + air (35° C.) | | | | |
| 8c) Additional 2 hr clean | 44.6 | +45% | 97.9% | 1 → 2 |
| with 0.2% NaOH + air | | | | |
| (35° C.) | | | | |

As can be seen from the results above, the addition of air bubbles consistently improves cleaning and is most effective in improving flux, salt rejection and turbidity when combined with proprietary cleaners with the properties discussed above. One notable anomaly in the test above is the effectiveness of Genesol 704 without additional air bubbles. As will be understood by those skilled in the art, membrane fouling is not uniform accordingly one coupon taken from the membrane may react differently to another. It is noted that a visual inspection of the coupons showed a similar amount of foulant removal as between example 6 and comparative example 5. after the cleans the flux rate was 90% of the design value for example 6 and 100% for comparative example 5, having been 65% of the design value before the clean.

Overall, the test results show that addition of air bubbles produced by the venturi result in improved flux, salt rejection and turbidity. The results are most effective when a cleaner having the properties discussed above, including a surfactant and effervescent reagents are used together with the bubbles of air. In a data set of 23 pairs of cleans with various typical cleaners in addition to those discussed above, each pair being one test with air and one without, the average flux change without the addition of the bubbles was 43.0 compared to 59.1 when bubbles were included. This represents a 37.3% improvement by using air bubbles.

The apparatus of the present invention has the advantage that the only additional piece of equipment that is required to an existing CIP set-up is a venturi valve (one end open to atmosphere) which is plumbed simply into the existing CIP pipe work on the cleaning solution feed side. The air-assisted CIP cleans can be carried out on multiple membrane elements within a pressure vessel (MPV). The combination of air bubbles with the cleaning solution and the additional air bubbles generated by the cleaning chemicals themselves (13 and 22) helps further to dislodge/scour any foulants from the membrane surfaces by promoting turbulence and thereby eases their removal.

Accordingly, it can be seen that the present invention can be industrially applied with the following advantages.
1) Increased effectiveness of air assisted CIP cleans compared with cleaning with chemicals alone, whether specialty cleaners or commodity cleaners.
2) An apparatus which is simple to apply to full-sized CIP RO/NF plants. No compressed air is needed as the air intake is directly from atmosphere at atmospheric pressure and also generated in situ by the cleaning chemicals. Can be applied to spiral wound RO and NF membranes.
3) Shorter cleaning times and an ability to penetrate and help remove biological, organic and inorganic deposits compared to cleaning with chemicals alone.
4) Increased permeate flux after the air-assisted cleans.
5) Reduced differential pressures after the air-assisted cleans.
6) Minimises foulant build-up on membrane surfaces, if used as a regular maintenance cleaning program.
7) Cleaning efficiency can be increased by up to 30-50% and membrane life can be extended 1-2 years.
8) No damage to membranes.

Although the invention is disclosed above with reference to specific examples, it will be understood that it is not limited to the particular embodiments and should be defined by reference to the following claims.

1. A method of cleaning reverse osmosis (RO) or nanofiltration (NF) membranes comprising supplying pulses of bubbles to the membrane.

2. A method of cleaning RO or NF membranes according to claim 1 wherein the pulses of bubbles are suspended in a stream of cleaning solution.

3. A method of cleaning RO or NF membranes according to claim 1 wherein the bubbles are created by a venturi device.

4. A method of cleaning RO or NF membranes according to claim 1 wherein the bubbles are stabilised by a cleaning product provided in the liquid stream.

5. A method of cleaning RO or NF membranes according to claim 1 wherein the flow of bubbles is enhanced by use of an effervescent cleaning product.

6. A method according to claim 5 wherein the cleaning product includes a surfactant.

7. A method according to claim 6 wherein the cleaning product is a powdered cleaning product.

8. A method according to claim 7 wherein the cleaning product is selected from Genesol® 701, Genesol® 703 and Genesol® 704.

9. A method according to claim 1 comprising supplying a first flow of fluid containing a pulse of bubbles and a first cleaning product then supplying a second flow of fluid containing a pulse of bubbles and a second cleaning product.

10. A venturi device for supplying bubbles to improve cleaning of RO or NF membranes, the venturi comprising a liquid inlet, an air-inlet provided at a choked portion of the venturi and an outlet; wherein the air inlet is provided with a plurality of tubes.

11. A venturi device according to claim 10 wherein the plurality of tubes are capillary tubes.

12. A venturi device according to claim 10 wherein the plurality of tubes have a length and diameter adapted to cause pulses of bubbles to enter the liquid flow through the device.

13. A venturi device according to claim 10 wherein the diameter of the plurality of tubes is between 0.5 and 1.0 mm and the length of the plurality of tubes is between 10 and 50 mm.

14. A venturi device according to claim 10 wherein the plurality of tubes as from 2 to 16 tubes.

15. A venturi device according to claim 10 wherein the plurality of tubes are at least 8 tubes.

16. A RO plant comprising a membrane pressure vessel having a fluid inlet, a permeate outlet and a concentrate outlet and an in place cleaning tank connected in line with the fluid inlet; characterised in that a venturi valve is connected in-line between the cleaning tank and the fluid inlet.

17. A RO plant according to claim 16 wherein the venturi is connected in line via a bypass line.

18. A RO plant according to claim 16 wherein the venturi valve is a venturi device for supplying bubbles to improve cleaning of RO or NF membranes, the venturi comprising a liquid inlet, an air-inlet provided at a choked portion of the venturi and an outlet; wherein the air inlet is provided with a plurality of tubes.

19. A RO plant according to any of claim 16 adapted to carry out the method of cleaning reverse osmosis (RO) or nanofiltration (NF) membranes comprising supplying pulses of bubbles to the membrane.

20. A method according to claim 1 wherein the bubbles are between 50 and 500 μm in size.

21. A method, venturi device or RO plant according to claim 19 wherein at least some bubbles are between 50 and 100 μm and at least some bubbles are between 100 and 500 μm.
